(19) United States
(12) Patent Application Publication
(10) Pub. No.: US 2016/0381330 A1
(43) Pub. Date: Dec. 29, 2016

(54) PROJECTION SYSTEM

(71) Applicant: BenQ Materials Corporation, Taoyuan City (TW)

(72) Inventor: Fung-Hsu WU, Taoyuan City (TW)

(21) Appl. No.: 15/132,259

(22) Filed: Apr. 19, 2016

(30) Foreign Application Priority Data
Jun. 26, 2015 (TW) 104120774

(51) Int. Cl. H04N 9/31

(52) U.S. Cl. CPC H04N 9/3155

(57) ABSTRACT

A projection system includes a light source, a projection screen having a laminated structure including a light switching device and a light absorbing layer, a projector device, and a control module electrically connected to the light source and the light switching device of the projection screen for synchronously controlling the switching frequency and time sequence of the light source and the light switching device. The projection system can provide an image with better contrast and color saturation in the condition of bright environment.

### RELATED APPLICATIONS

This application claims priority to Taiwanese Application Serial Number 104120774, filed Jun. 26, 2015, which is herein incorporated by reference.

### BACKGROUND OF THE DISCLOSURE

Field of the Disclosure

The present disclosure relates to a projection system, and more particularly to a projection system for enhancing the contrast of images in a bright environment.

Description of the Related Art

A conventional projection system usually uses a non-penetrating backlight, and a projection screen itself of the projection system does not emit light and generate images. The images are projected onto a projection screen by a projector device, and scattered or reflected to the eyes of users. Lights other than that from the projector device may also be emitted onto the projection screen at the same time, which will affect the image quality. Therefore, using the conventional projection system needs to be under the dark environment generally to obtain images with well contrast and color saturation. However, the dark environment will cause inconvenience of the user to read, walk or deal with other matters at the same time if it needs to use the conventional projection system under bright conditions, such as indoors with light source or daytime outdoors, the display image will easily generate co or washout, which results in a substantial decline in contrast and color saturation, and the display quality is poor accordingly. The methods proposed to improve the shortcoming are generally to increase the flux of the projection light source, or to use a high-gain projection screen to increase the effective brightness of the projection. However, the methods will increase energy consumption and costs of the projection system, and only reduce the influence of ambient light relatively. Color washout caused by ambient light still cannot be completely avoided.

As the result, it still exists a need to provide a projection system with better contrast and color saturation in the situation of brighter ambient lighting.

### SUMMARY OF THE DISCLOSURE

The present disclosure is to provide a projection system. In an embodiment of the present disclosure, the projection system includes a light source for providing ambient lighting, a projection screen having a laminated structure including a light absorbing layer a lid a light switching device facing to the light source, a projector device for projecting an image onto the projection screen, and a control module electrically connected to the light source and the light switching device of the projection screen for synchronously controlling the switching frequency and time sequence of the light source and the light switching device, wherein the switching frequency is in a range of 60 Hz to 1000 Hz. When the light source is turned on, the light switching device is in a transparent state; when the light source is turned off, the light switching device is in a scattering opaque state.

In another preferred embodiment of the projection system of the present disclosure, the light switching device is a polymer-dispersed liquid crystal device, a polarizing dimming device or a refractive dimming device.

In another preferred embodiment of the projection system of the present disclosure, the light source includes light emitting diodes (LED) or organic light emitting diodes (OLED).

In another preferred embodiment of the projection system of the present disclosure, the reflectivity of the light absorbing layer of the projection screen is in a range of 1% to 20%.

In another preferred embodiment of the projection system of the present disclosure, the control module is further electrically connected to the projector device, and when t he light source is turned on the projector device is turned off synchronously.

### BRIEF DESCRIPTION OF THE DRAWINGS

The above and other aspects of the disclosure will become better understood with regard to the following detailed description of the preferred but non-limiting embodiment(s). The following description is made with reference to the accompanying drawings.

FIG. 1 shows a schematic diagram of the projection system of preferred exemplary embodiment of the present disclosure;

FIG. 2a and FIG. 2b illustrate the principle of the projection system of a preferred exemplary embodiment of the present disclosure; and

FIG. 3 shows the time sequence diagram of the control module of the projection system of a preferred exemplary embodiment of the present disclosure.

### DETAILED DESCRIPTION OF THE DISCLOSURE

Please note the drawings shown in the Figures are for illustrative purposes only and not to scale.

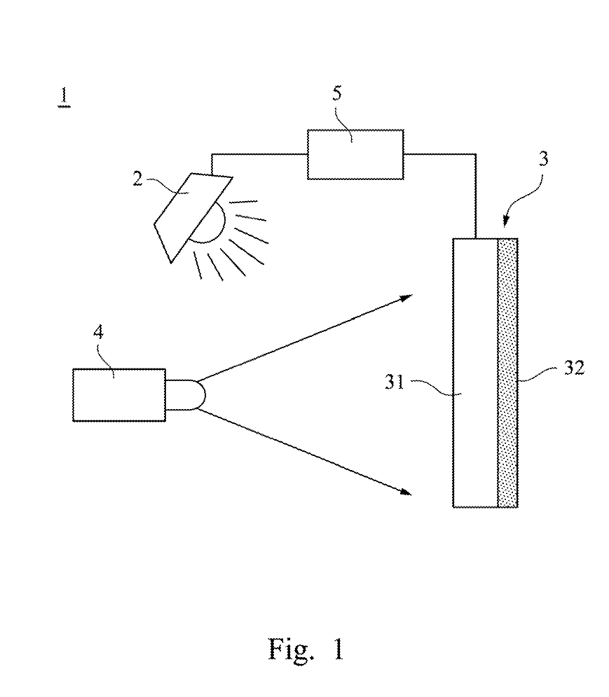

Referring to FIG. 1, in an embodiment of the present disclosure, a projection system 1 includes a light source 2 for providing an ambient lighting, a projection screen 3 having a laminated structure including a light switching device 31 and a light absorbing layer 32, wherein the light switching device 31 is facing to the side of the light source 2, a projector device 4 for projecting an image onto the projection screen 3, and a control module 5 electrically connected to the light source 2 and the light switching device 31 of the projection screen 3 for synchronously controlling the switching frequency and time sequence of the light source 2 and the light switching device 31, wherein the switching frequency is in a range of 60 Hz to 1000 Hz. When the light source 2 is turned on, the light switching device 31 is in a transparent state; when the light source 2 is turned off, the light switching device 31 is in a scattering opaque state.

In another preferred embodiment of the projection system of the present disclosure, the light switching device is a polymer-dispersed liquid crystal device, a polarizing dimming device or a refractive dimming device.

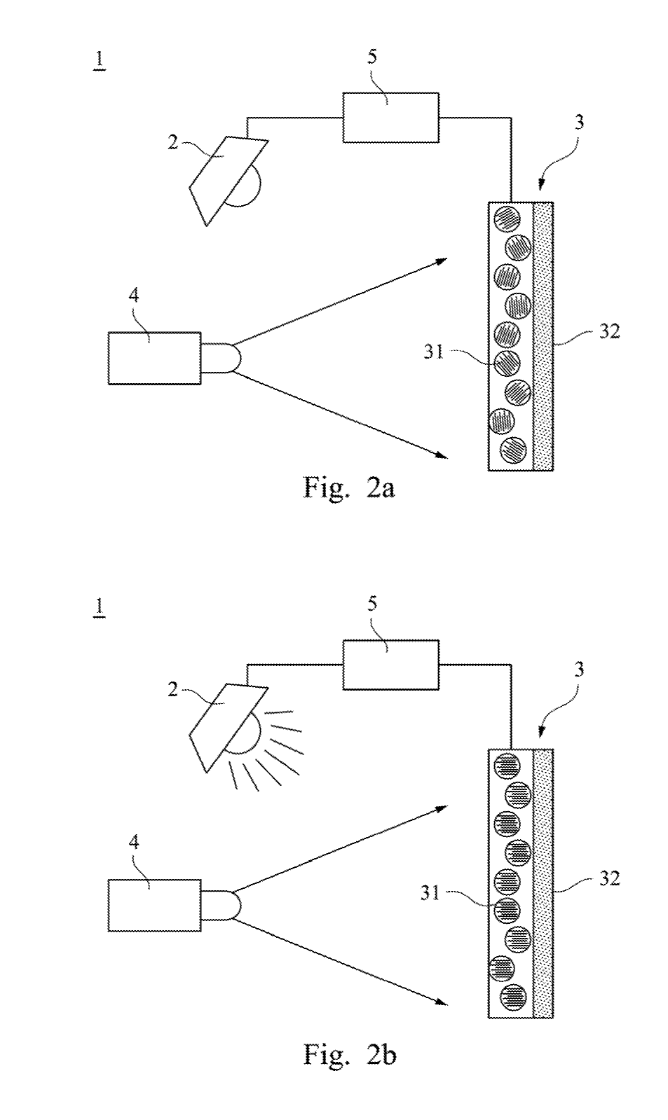

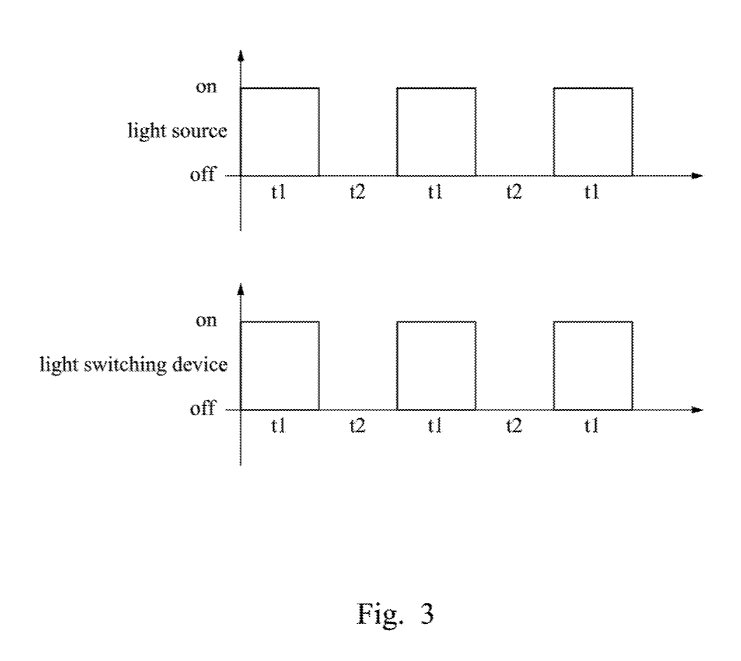

Referring to FIG. 2a and FIG. 2b, FIG. 2a and FIG. 2b illustrate the principle of the projection system of the present disclosure. For example, the light switching device 31 is a polymer-dispersed liquid crystal device. When the user needs to use the projector device 4 under brighter indoor ambient light, the control module 5 can synchronously control the light source 2 and the light switching device 31 with a fast switching frequency. Also referring to FIG. 3, FIG. 3 shows the time sequence diagram of the control module 5 of the projection system 1. When the control module 5 is at time point t2, the light source 2 and the light switching device 31 are turned off synchronously, and polymer-dispersed liquid crystals in the light switching device 31 are in a scattered state of irregular arrangement. The images on the projection screen 3 will not generate color washout by the influence of the light source 2. When the control module 5 is at time point t1, the light source 2 and the light switching device 31 are turned on synchronously, and the polymer-dispersed liquid crystals in the light switching device 31 are in a transparent state of regular arrangement. The light emitted by the light source 2 and the images projected by the projector device 4 are absorbed by the light absorbing layer 32 of the projection screen 3 and display a black frame. Because the switching frequency of the control module 5 is greater than the visual speed of human eyes, the light source 2 seems to be turned on continuously. Therefore, the projection system 1 can obtain an effect of better contrast and color saturation with an ambient lighting.

In another preferred embodiment of the projection system of the present disclosure, the light source includes at least one light emitting diode (LED) or organic light emitting diode (OLED) which has very short driving time, and can be quickly switched.

In another preferred embodiment of the projection system 1 of the present disclosure, the reflectivity of the light absorbing layer 32 of the projection screen 3 is in a range of 1% to 20%, so that the light penetrating to the light switching device 31 is not easy to be reflected to the user's eyes.

In another preferred embodiment of the projection system 1 of the present disclosure, the control module 5 is further electrically connected to the projector device 4, and when the light source 2 is turned on, the projector device 4 can be turned off synchronously for energy saving.

While the disclosure has been described by way of example and in terms of the preferred embodiment(s), it is to be understood that the disclosure is not limited thereto. On the contrary, it is intended to cove r various modifications and similar arrangements and procedures, and the scope of the appended claims therefore should be accorded the broadest interpretation so as to encompass all such modifications and similar arrangements and procedures.

What is claimed is:

1. A projection system comprising:
a light source for providing ambient lighting;
a projection screen having a laminated structure comprising a light itching device and a light absorbing layer, wherein the light switching device is facing to a side of the light source;
a projector device for projecting an image onto the projection screen; and
a control module electrically connected to the light source and the light switching device of the projection screen for synchronously controlling switching frequency and time sequence of the light source and the light switching device, wherein the switching frequency is in a range of 60 Hz to 1000 Hz, and when the light source is turned on, the light switching device is in a transparent state; when the light source is turned off, the light switching device is in a scattering opaque state.

2. The projection system according to claim 1, wherein the light switching device is a polymer-dispersed liquid crystal device a polarizing dimming device or a refractive dimming device.

3. The projection system according to claim 1, wherein the light source comprises light emitting diodes (LED) or organic light emitting diodes (OLED).

4. The projection system according to claim 1, wherein the reflectivity of the light absorbing layer of the projection screen is in a range of 1% to 20%.

5. The projection system according to claim 1, wherein the control module is further electrically connected to the projector device, and when the light source is turned on, the projector device is turned off synchronously.
